(19) United States
(12) Patent Application Publication
(10) Pub. No.: US 2018/0027768 A1
(43) Pub. Date: Feb. 1, 2018

(54) ANIMAL COOLING GARMENT

(71) Applicant: Robin Spaziano, Scituate, RI (US)

(72) Inventor: Robin Spaziano, Scituate, RI (US)

(21) Appl. No.: 15/666,520

(22) Filed: Aug. 1, 2017

Related U.S. Application Data
(60) Provisional application No. 62/369,535, filed on Aug. 1, 2016.

(51) Int. Cl. A01K 13/00; A01K 27/00

(52) U.S. Cl. CPC A01K 13/006; A01K 13/008; A01K 27/002

(57) ABSTRACT

A body-cooling garment includes an absorbent-body, and a pocket which may be configured to house a cooling means. The body-cooling garment may further include a leash-connection ring. The garment may be submerged in cold water and used to evaporatively cool a user, and the cooling means may provide further cooling to the user.

### CROSS REFERENCE TO RELATED APPLICATION

The present application is related to and claims priority to U.S. Provisional Patent Application No. 62/369,535 filed Aug. 1, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of garments and more specifically relates to garments for cooling animals.

### 2. DESCRIPTION OF RELATED ART

It can be difficult for dogs, especially military and police dogs, to keep cool in hot weather for extended periods of time. Many animals have limited abilities to dissipate heat. For example, dogs attempt to reduce their body temperature through their paws or by panting. These mechanisms, however, have a limited effect and, as a consequence, dogs tend to overheat when exposed to direct sunlight and avoid participating in outdoor activities. Some dog owners may constantly give their dog water or provide shade for their dog when outside, but unfortunately, this may not be enough to stave off these conditions or symptoms. Thus, a suitable solution is desired.

U.S. Pub. No. 2008/0040839 to Gordon relates to a flexible cooling garment. The described flexible cooling garment includes a wearable garment to evaporatively cool humans and animals. The garment contains a body portion and an attachment portion. The body portion is generally defined by at least one outer seam. The body portion contains three layers; an outer layer, a middle layer, and an inner layer. The outer layer is comprised of a breathable fabric. The middle layer is comprised of a substantially hydrophilic material. The inner layer is substantially hydrophobic, preferably comprising a layer of finely woven substantially hydrophobic fibrous material. The attachment portion contains at least one means for attaching the garment to a wearer. To activate the cooling process, the garment is first immersed in water, wherein the middle layer absorbs water. The wearer then wrings the excess water from the garment and places the garment on the desired body region to be cooled.

### BRIEF SUMMARY OF THE INVENTION

In view of the foregoing disadvantages inherent in the known garments art, the present disclosure provides a novel animal cooling garment. The general purpose of the present disclosure, which will be described subsequently in greater detail, is to provide a garment configured to provide prolonged cooling means to an animal.

A body-cooling garment is disclosed herein. The body-cooling garment may include an absorbent-body including an inner-surface, an outer-surface, a head-opening and at least two side-openings that may be located opposite each other. The absorbent-body may be configured to attach to a body of a user via the head-opening and the at least two side-openings, and the absorbent may be further configured to retain a liquid. Further, a pocket may be fixedly attached to the outer-surface, and the pocket may include an inner-capacity configured to house a cooling means. The body-cooling garment may be configured to cool the body of the user.

A method of using a body-cooling garment is also disclosed herein. The method of using body-cooling garment may comprise the steps of: comprising the steps of: providing the body-cooling garment as above, submerging the body-cooling garment in the liquid; removing an excess of the liquid from the body-cooling garment; pulling the body-cooling garment over a head of the user via the head-opening; inserting a limb of the user through each of the at least two-side openings; and cooling the body of the user via the liquid.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an animal cooling garment, constructed and operative according to the teachings of the present disclosure.

FIG. 1A is a front perspective view of the body-cooling garment during an ‘in-use’ condition, according to an embodiment of the disclosure.

FIG. 1B is a front perspective view of the body-cooling garment during an ‘in-use’ condition, according to an embodiment of the disclosure.

FIG. 2 is a variety of views of the body-cooling garment of FIG. 1, according to an embodiment of the present disclosure.

FIG. 3 is a perspective view of the body-cooling garment of FIG. 1, according to an embodiment of the present disclosure.

FIG. 4 is a front perspective view of an alternative embodiment of the body-cooling garment of FIG. 1.

FIG. 5 is a flow diagram illustrating a method of use for the body-cooling garment, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to garments and more particularly to an animal cooling garment as used to improve cooling of animals.

Generally disclosed is a safe and convenient way to keep dogs cool and comfortable in hot weather. The animal-cooling garment may slip over a dog's head and two front paws for easy wear. The present disclosure may help prevent exhaustion, heat stroke, and other heat-induced conditions; thus, the animal-cooling garment may offer peace of mind to dog owners by keeping dogs cool and comfortable in the hot summer sun. The device may be useful for different animals.

The animal-cooling garment may include a pocket for a frozen gel pack and a harness ring for maximum convenience. The animal cooling garment may be a cooling tank top for dogs exposed to hot weather, particularly police and military dogs. The tank top may be made from PVA sponge material, designed to be submerged in cold water before use, wrung out, and put on a dog prior to exposure to the heat in order to keep them cool for approximately up to two hours. The top may be offered in assorted sizes to accommodate a wide range of dog breeds.

The tank top may be submerged or sprayed down to remain cool. Additionally, the tank top may include the pocket on the back, designed to hold the optional frozen pack, so that when it melts it keeps the tank top moist and cool. Further, a grosgrain ribbon may be attached to the pocket. Threaded to the ribbon nay be a metal harness ring.

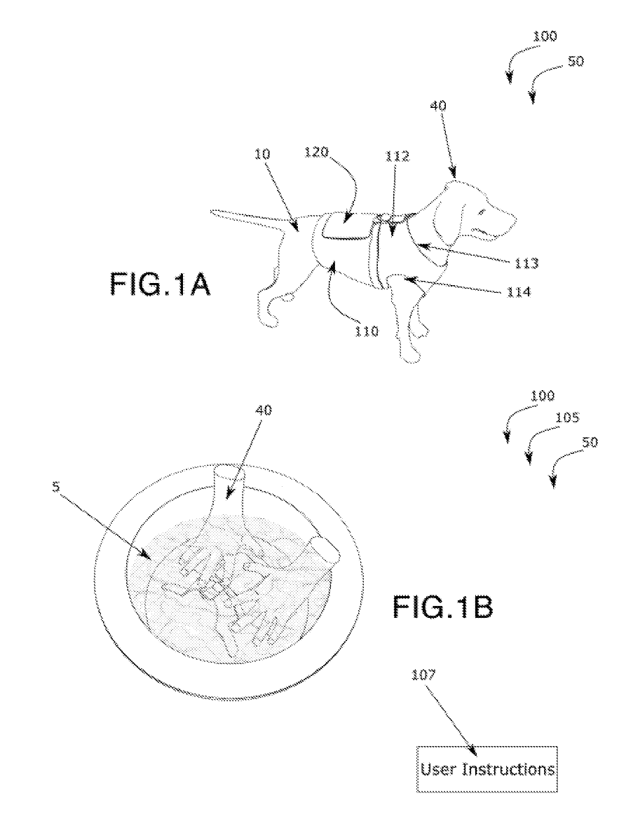

Referring now more specifically to the drawings by numerals of reference, there is shown in FIGS. 1A-5, various views of a body-cooling garment 100.

FIG. 1A shows a body-cooling garment 100 during an ‘in-use’ condition 150, according to an embodiment of the present disclosure. As illustrated, the body-cooling garment 100 may include an absorbent-body 110 and a pocket 120. The body-cooling garment 100 may configured to cool the body of the user 40. The absorbent-body may include an inner-surface 111, an outer-surface 112, a head-opening 113 and at least two side-openings 114 opposite each other. The absorbent-body 110 may be configured to attach to a body of a user 40 via the head-opening 113 and the at least two side-openings 114.

As shown, in the preferred embodiment, the user 40 may be a dog 10. In this embodiment, the at least two-side openings 114 may each be configured to receive a front paw of the dog 10, respectively. Further, in this preferred embodiment, the body-cooling garment may include the absorbent-body 110 including the inner-surface 111, the outer-surface 112; the head-opening 113 and at least two paw-openings 118 opposite each other. The absorbent-body 110 may be configured to attach to a body of a dog 10 via the head-opening 113 and the at least two paw-openings 118, and the absorbent-body 110 may be further configured to retain the liquid 5; further, the body-cooling garment may be configured to cool the body of the dog 10.

In a further example, the user 40 may be a horse. In this embodiment, the at least two-side openings 114 may each be configured to receive a front leg of the horse, respectively. It is appreciated that the body-cooling garment 100 is not limited for wear by the dog 10 or the horse, and may be worn by a human of all ages. The body-cooling garment 100 may be manufactured in a variety of sizes and shapes to accommodate all species and breeds of animal, and all ages of human.

FIG. 1B shows a body-cooling garment 100 during an ‘in-use’ condition 150, according to an embodiment of the present disclosure. As above, the absorbent-body 110 may be configured to retain a liquid 5. Further, the absorbent-body 110 may be configured to cool the body of the user 40 via the liquid 5. Shown here is the absorbent-body 110 being submerged in the liquid 5. The liquid 5 may preferably have a cold temperature. Once submerged, the absorbent-body 110 may retain the liquid 5 and be worn to evaporatively cool the user 40.

According to one embodiment, the body-cooling garment 100 may be arranged as a kit. The kit may include a set of instructions 107. The instructions 107 may detail functional relationships in relation to the structure of the body-cooling garment 100 (such that the body-cooling garment 100 can be used, maintained, or the like, in a preferred manner).

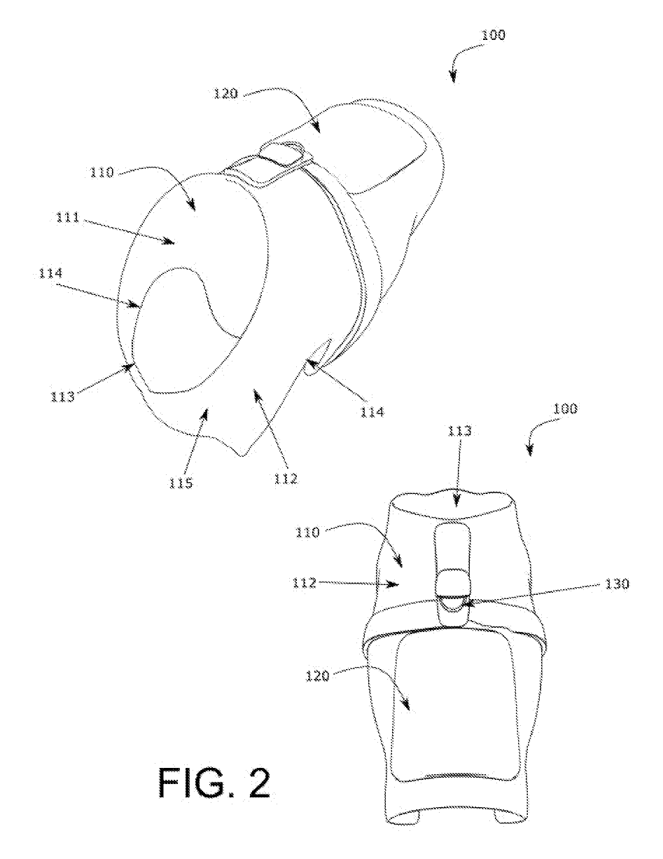

FIG. 2 shows various perspective views of the body-cooling garment 100 of FIG. 1A, according to an embodiment of the present disclosure. As above, the body-cooling garment 100 may include an absorbent-body 110 including the inner-surface 111, the outer-surface 112, the head-opening 113 and the at least two side-openings 114 opposite each other. The absorbent-body 110 may be configured to attach to the body of a user 40 via the head-opening 113 and the at least two side-openings 114 (as shown in FIG. 1A).

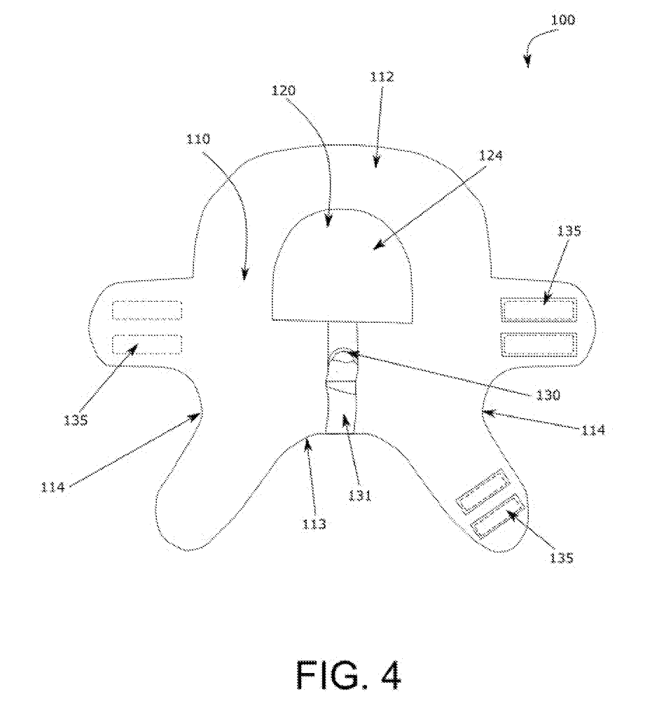

The absorbent-body 110 may be made from a hydrophilic material 115. In a preferred embodiment, the hydrophilic material 115 may be a synthetic sponge composed of Polyvinyl Alcohol. It should be appreciated that the absorbent-body 110 is not limited to the synthetic sponge composed of Polyvinyl Alcohol. Any wicking material, or non-wicking material may be used. In the preferred embodiment, the absorbent-body 110 may be a vest-top with no attachment-portion 135 (attachment-portion 135 shown in FIG. 4), which may be pulled over the head of the user 40.

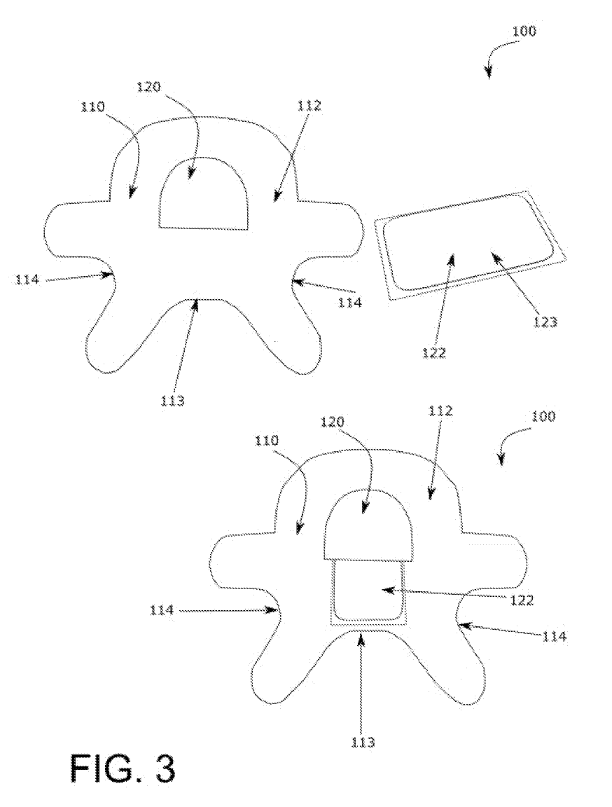

FIG. 3 shows various views of the pocket 120 and the cooling means 122 of the body-cooling garment 100 of FIG. 1, according to an embodiment of the present disclosure. As shown, the pocket 120 may be fixedly attached to the outer-surface 112 and may include an inner-capacity 121 configured to house a cooling means 122. The pocket 120 may be the hydrophilic material 115. Similar to the absorbent-body 110, the hydrophilic material may be a synthetic sponge composed of Polyvinyl Alcohol. Other materials may be used.

Also shown here is the cooling means 122. In the preferred embodiment, the cooling means 122 may be a frozen gel-pack 123. The frozen gel-pack 123 may include a refrigerant gel configured to absorb a considerable amount of heat before warming above 0° C. In another example, the cooling means 122 may be an ice-pack filled with frozen water.

FIG. 4 shows a front perspective view of the body-cooling garment 100 of FIG. 1A, according to an embodiment of the present disclosure. As shown, the body-cooling garment may further include a leash-connection ring 130 attached to an outer-surface 124 of the pocket 120. In the preferred embodiment, the body-cooling garment may additionally include a decorative ribbon 131 configured to attach the leash-connection ring 130 to the outer-surface 124 of the pocket 120. The decorative ribbon 131 may be manufactured in a variety of colors, patterns, designs, etc. Materials such as lace, silk, wood, may be used. It is appreciated that the decorative feature may not be limited to ribbon. In the preferred embodiment in which the user 40 is the dog 10, a leash may be attached to the leash-connection ring 130 for use whilst walking the dog 10.1

In the preferred embodiment, the body-cooling garment 100 may be a vest-top with no attachment-portion 135 (FIG. 2), which may be pulled over the head of the user 40. Illustrated here is an alternative embodiment to the preferred embodiment, wherein the body-cooling garment includes an attachment-portion 135 configured to attach the garment to the body of the user 40. Here, the attachment-portion 135 may be a hook and loop fastener such as VELCRO®. In further examples, the attachment-portion 135 may be a zipper, a button-fastener, a hook and eye fastener, or the like.

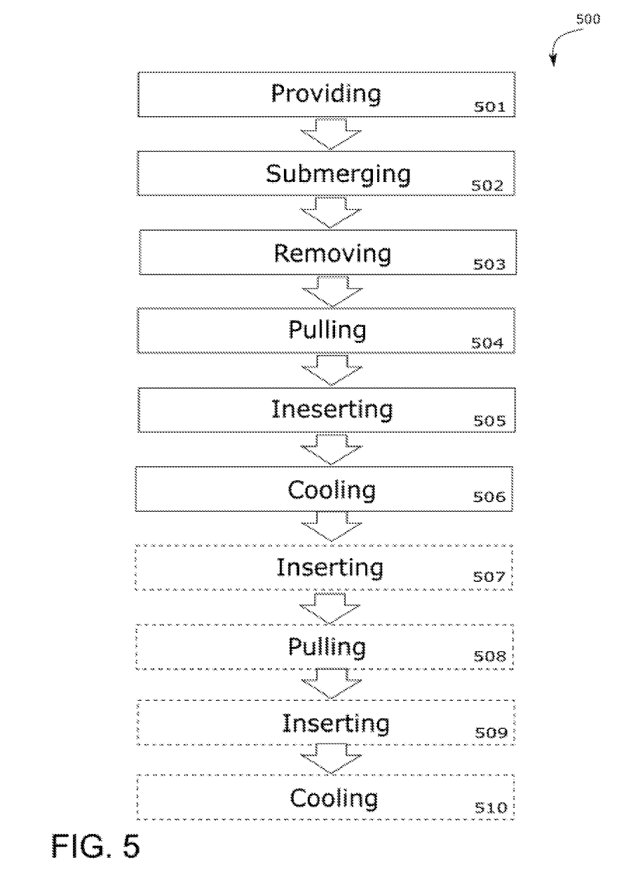

FIG. 5 is a flow diagram 550 illustrating a method of using a body-cooling garment to cool a body of a user 500, according to an embodiment of the present disclosure. As illustrated, the method of using 500 a body-cooling garment to cool a body of a user may include the steps of: comprising the steps of: step one 501, providing the body-cooling garment 100 as above; step two 502, submerging the body-cooling garment in the liquid 5; step three 503, removing an excess of the liquid 5 from the body-cooling garment; step four 504, pulling the body-cooling garment over a head of the user 40 via the head-opening 113; step five 505, inserting a limb of the user 40 through each of the at least two-side openings 114; and step six 506, cooling the body of the user 40 via the liquid 5.

Further steps may include: step seven 507, inserting a cooling means 122 within the inner-capacity 121 of the pocket 120; step eight 508, pulling the body-cooling garment over the head of the user 40 via the head-opening 113; step nine 509, inserting the limb of the user 40 through each of the at least two-side openings 114; and step ten 510, cooling the body of the user 40 via the liquid 5 and the cooling means 122.

It should be noted that step seven 507, step eight 508, step nine 509 and step ten 510 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for using body-cooling garment 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A body-cooling garment comprising:
an absorbent-body including an inner-surface, an outer-surface, a head-opening and at least two side-openings, the at least two side-openings being opposite each other, the absorbent-body being configured to attach to a body of a user via the head-opening and the at least two side-openings, and wherein the absorbent is further configured to retain a liquid; and
a pocket fixedly attached to the outer-surface, the pocket including an inner-capacity configured to house a cooling means; and
wherein the body-cooling garment is configured to cool the body of the user.

2. The body-cooling garment of claim 1, wherein the absorbent-body is a hydrophilic material.

3. The body-cooling garment of claim 2, wherein the hydrophilic material is a synthetic sponge composed of Polyvinyl Alcohol.

4. The body-cooling garment of claim 1, wherein the absorbent-body is a vest-top.

5. The body-cooling garment of claim 1, wherein the absorbent-body is configured to cool the body of the user via the liquid.

6. The body-cooling garment of claim 1, wherein the cooling means is a frozen gel-pack.

7. The body-cooling garment of claim 1, wherein the cooling means is an ice-pack.

8. The body-cooling garment of claim 1, wherein the user is a dog.

9. The body-cooling garment of claim 8, wherein the at least two-side openings are each configured to receive a front paw of the dog, respectively.

10. The body-cooling garment of claim 1, wherein the wherein the user is a horse.

11. The body-cooling garment of claim 10, wherein the at least two-side openings are each configured to receive a front leg of the horse, respectively.

12. The body-cooling garment of claim 1, wherein the garment further includes a leash-connection ring attached to an outer-surface of the pocket.

13. The body-cooling garment of claim 12, wherein the garment further includes a decorative ribbon configured to attach the leash-connection ring to the outer-surface of the pocket.

14. The body-cooling garment of claim 1, wherein the pocket is the hydrophilic material.

15. The body-cooling garment of claim 1, wherein the absorbent-body further includes an attachment-portion configured to attach the garment to the body of the user.

16. The body-cooling garment of claim 15, wherein the attachment-portion is a hook and loop fastener.

17. A body-cooling garment comprising:
an absorbent-body including an inner-surface, an outer-surface, a head-opening and at least two paw-openings, the at least two paw-openings being opposite each other, the absorbent-body being configured to attach to a body of a dog via the head-opening and the at least two paw-openings, and wherein the absorbent-body is further configured to retain a liquid; and
a pocket fixedly attached to the outer-surface, the pocket including an inner-capacity configured to house a cooling means; and
wherein the body-cooling garment is configured to cool the body of the dog;
wherein the absorbent-body is a hydrophilic material;
wherein the hydrophilic material is a synthetic sponge composed of Polyvinyl Alcohol;
wherein the absorbent-body is a vest-top;
wherein the absorbent-body is configured to cool the body of the user via the liquid;
wherein the cooling means is a frozen gel-pack;
wherein the garment further includes a decorative ribbon configured to attach a leash-connection ring to the outer-surface of the pocket; and
wherein the pocket is also of the hydrophilic material.

18. The body-cooling garment of claim 17, further comprising set of instructions; and
wherein the body-cooling garment is arranged as a kit.

19. A method of using a body-cooling garment to cool a body of a user, the method comprising the steps of:
providing the body-cooling garment including:
an absorbent-body including an inner-surface, an outer-surface, a head-opening and at least two side-openings, the at least two side-openings being opposite each other, the absorbent-body being configured to attach to a body of a user via the head-opening and the at least two side-openings, and wherein the absorbent is further configured to retain a liquid; and
a pocket fixedly attached to the outer-surface, the pocket including an inner-capacity configured to house a cooling means;
submerging the body-cooling garment in the liquid;
removing an excess of the liquid from the body-cooling garment;
pulling the body-cooling garment over a head of the user via the head-opening;
inserting a limb of the user through each of the at least two-side openings; and
cooling the body of the user via the liquid.

20. The method of claim 19, further comprising the steps of:
inserting a cooling means within the inner-capacity of the pocket;
pulling the body-cooling garment over the head of the user via the head-opening;
inserting the limb of the user through each of the at least two-side openings; and
cooling the body of the user via the liquid and the cooling means.
